(19) United States
(12) Patent Application Publication
(10) Pub. No.: US 2015/0082956 A1
(43) Pub. Date: Mar. 26, 2015

(54) ELECTRIC PLANING KNIFE

(71) Applicant: Zongmao LOU, Ninghai (CN)

(72) Inventor: Zongmao LOU, Ninghai (CN)

(21) Appl. No.: 14/325,799

(22) Filed: Jul. 8, 2014

(30) Foreign Application Priority Data
Sep. 23, 2013 (CN) 20131444791
Sep. 23, 2013 (CN) 201320597679.8

(51) Int. Cl. B43L 23/08

(52) U.S. Cl. CPC B43L 23/08
USPC 83/67

(57) ABSTRACT

An electric planing knife comprising: a knife rest with a planing cavity formed within the knife rest and adapted to permit insertion of a pencil-shape object; a cutter comprising a blade, wherein the cutter is mounted within said planing cavity; and an electric circuit disconnector comprising a trip lever and a resilient elastic reset switch, said elastic reset switch being disposed under said planing cavity, the upper end of said elastic reset switch being located within said planing cavity, the upper end of said trip lever being connected with said elastic reset switch and being disposed below said elastic reset switch, said elastic reset switch being electrically connected to said cutter; and a sharpness adjustor below the planing cavity.

### BACKGROUND OF THE INVENTION

1. Field of the Invention

The present application relates to a planing apparatus, more particularly, relates to an electric planing knife which can sharpen an end of a pencil-shape object, adjust the sharpness of the pencil-shape objects' end, and automatically stop.

2. Description of the Related Art

When using conventional electric pencil sharpeners sharpen pencil-shape objects, users need to determine whether the pencil-shape objects are sharpened based on their subjective sense alone, which can easily cause inadequate or excessive planing. If a pencil is not sharp enough, one must re-sharpen the pencil, which consumes energy and time. On the other hand, excessive planing wastes materials and shortens the lifespan of the pencil. In addition, conventional electric pencil sharpeners generally cannot adjust the sharpness of a sharpened end of a pencil-shape object to a predetermined degree. Users often have to determine the sharpness of the sharpened end of a pencil-shape object based on their subjective sense.

Therefore, it is necessary to provide an electric pencil sharpener which can adjust the size of a pencil-shape objects' tip and automatically stop planing after the tip satisfies a pre-determined standard, therefore overcoming the above-discussed drawbacks of conventional pencil sharpeners.

### SUMMARY OF THE INVENTION

The object of the present invention is to provide an electric planing knife which is convenient, has a simple structure, can both adjust sharpness of a tip of a pencil-shape object and automatically stop the planing after the tip satisfies a pre-determined standard.

Accordingly, the present invention provides an electric planing knife comprising: a planing mechanism and a knife rest, said knife rest having a planing cavity adapted to permit insertion of a pencil-shape object, a cutter assembly of said planing mechanism mounted into said planing cavity for planing the pencil-shape object; and said cutter assembly comprise a blade; and an electric circuit breaker comprising a trip lever and a resilient elastic reset switch, said elastic reset switch being disposed under said planing cavity and the upper end of said elastic reset switch being located inside said planing cavity, the upper end of said trip lever being connected with said elastic reset switch and being disposed below said elastic reset switch; said elastic reset switch electrically connected to said planing mechanism; and said trip lever being further provided with a sharpness adjustor.

Said sharpness adjustor preferably comprises a size adjustment slider being disposed below said trip lever and being pressed against the lower end of said trip lever, the contact surface between said size adjustment slider and said trip being inclined.

Said size adjustment slider is preferably provided with a toggle handle for facilitating moving said size adjustment slider.

A stopper is preferably provided at each end of said size adjustment slider to set a boundary in both forward and backward directions of said size adjustment slider.

Said trip lever is capable of moving axially in a guide sleeve and constrained in moving transversely.

The lower end of said trip lever has a spherical shape.

A waste collection box is placed beneath said knife rest.

This invention has following advantages: the tip of a pencil-shape object gradually moves towards the elastic reset switch, while being gradually cut. After the tip of the pencil-shape object touches the elastic reset switch, with the planing mechanism continuing planning, the pencil-shape object continues pressing the elastic reset switch. When the pencil-shape object extending into the planing cavity reaches for a predetermined length, the pencil-shape object presses against the elastic reset switch and turns off the planing mechanism, therefore achieving automatic planning of the pencil-shape object. Said elastic reset switch resets for next planing, after the pencil-shaped object is pulled out. The electric planing knife according to the present invention also has a sharpness adjustor, which regulates both the trip lever and elastic reset switch's overall relative location to the planing cavity, controlling the sharpness of the pencil-shape object's front tip by adjusting when the front tip of the pencil-shape object touches the elastic reset switch.

A circuit disconnector in accordance an embodiment of the present invention comprising said trip lever and said flexible elastic reset switch can simply, quickly, and automatically, and accurately control the planing knife, therefore enabling fast, accurate, and automatic planing of a pencil-shape object. The electronic planning knife in accordance with the present invention has a reasonable structure design, is easy to operate, and facilitates users to quickly obtain a sharpened pencil-shaped object.

The various features of novelty which characterize the invention are pointed out with particularity in the claims annexed to and forming a part of the disclosure. For a better understanding of the invention, its operating advantages, and specific objects attained by its use, reference should be had to the drawing and descriptive matter in which there are illustrated and described preferred embodiments of the invention.

### BRIEF DESCRIPTION OF THE DRAWINGS

In the drawings:

FIG. 1 is a perspective view of the outer appearance of an electric planing knife in accordance with an embodiment of the present invention.

FIG. 2 is a cross-sectional perspective view of an electric planing knife in accordance with an embodiment of the present invention.

FIG. 3 is a cross-sectional perspective view of an electric planing knife sharpening a pencil-shaped-object in accordance with an embodiment of the present invention.

FIG. 4 is a cross-sectional view of an electric planing knife sharpening a pencil-shaped object in accordance with another embodiment of the present invention.

FIG. 5 is a cross-sectional perspective view of an electric planing knife in accordance with an embodiment of the present invention.

### DETAILED DESCRIPTION OF THE PRESENTLY PREFERRED EMBODIMENTS

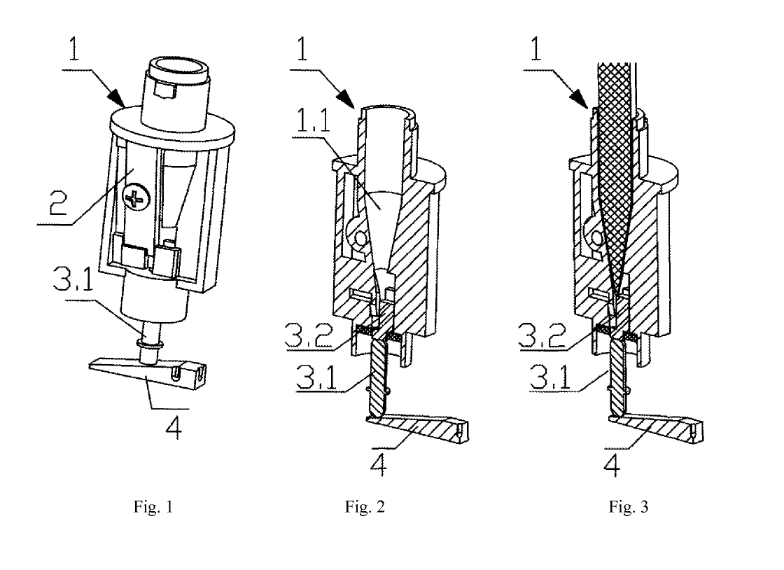

With reference to FIGS. 1 to 5, an electric planing knife in accordance with an embodiment of the present invention comprises a planing mechanism and a knife rest 1 with a planing cavity (1.1) formed in the knife rest 1 and adapted to permit insertion of a pencil-shape object, a cutter assembly of the planing mechanism mounted into said planing cavity 1.1 for planing the pencil-shape object, said cutter assembly comprising blade 2, said electric planing knife comprising an electric circuit disconnector which comprises a trip lever 3.1 and a resilient elastic reset switch 3.2, said elastic reset switch 3.2 being disposed under said planing cavity 1.1 and the upper end of said elastic reset switch 3.2 being located within said planing cavity 1.1, the upper end of said trip lever 3.1 being connected with said elastic reset switch 3.2 and being disposed below said elastic reset switch 3.2, said elastic reset switch 3.2 being electrically connected to said planing mechanism, said trip lever 3.1 is further provided with a sharpness adjustor. Said elastic reset switch 3.2 can be directly purchased on market, for example a contact switch on the market can be used as said elastic switch 3.2. The knife rest 1 is driven to plane a pencil-shape object by power provided by an installed rack worm and worm gear in an enclosed transmission frame. Choosing blade 2 as an alternative to the hobbing cutter in the prior art has following advantages: easy installation, low cost, easy exchange after a blade is worn, and reduced production cost.

Said sharpness adjustor preferably comprises a size adjustment slider 4 being disposed below said trip lever 3.1 and touching against the lower end of said trip lever 3.1, the contact surface between said size adjustment slider 4 and said trip lever 3.1 being inclined.

Said size adjustment slider 4 is preferably provided with a toggle handle for moving adjustment slider 4 conveniently.

A stopper is provided at each end of said size adjustment slider 4 in the forward and backward directions to set the boundary of the movement of said size adjustment slider 4.

Said trip lever 3.1 is constrained laterally and is capable of moving axially in the guide sleeve.

The lower end of said trip lever 3.1 has a spherical shape, which plays a guiding role, facilitates the movement of the size adjustment slider 4, squeezing the lower end of said trip lever 3.1, and facilitating axial movement of said trip lever 3.1.

A waste collection box 5 is preferably provided beneath the knife rest. The waste collection box 5 and the bottom shell of the present invention can be connected to each other by plug, screw or snap, etc., which facilitate dismantling of waste collection box 5 and waste dumping.

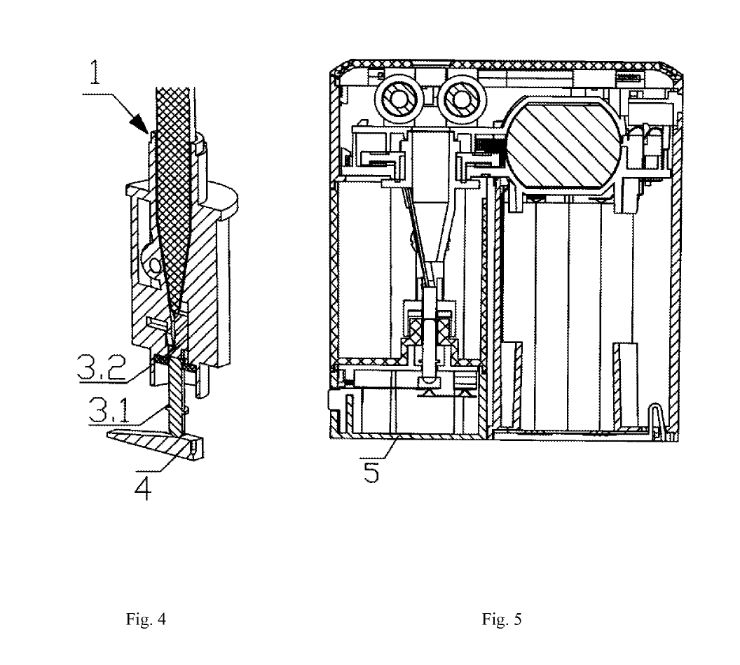

Referring to FIG. 3 and FIG. 4, a tip of a pencil-shape object gradually moves toward the said elastic reset switch, while being gradually sharpened. After the tip of the pencil-shape touches the elastic reset switch 3.2, with said planing mechanism continues planing, the pencil-shape object continues pressing against said elastic reset switch's 3.2. When the pencil-shape object extends into said planing cavity 1.1 for a predetermined length, the pencil-shape objects presses against the elastic reset switch 3.2 sufficiently so that it turns off said planing mechanism, therefore completing the planning of the pencil-shape object automatically. After the pencil-shape object is pulled out of the pencil, said elastic reset switch 3.2 resets for next planning. An electronic planing knife preferably also comprises a sharpness adjustor, which comprises pushing adjustment slider 4. The ball-shape end portion of the lower end of said trip lever 3.1 is pressed by the inclined surface of said adjustment slider 4, therefore enabling axial movement of said trip lever 3.1. Said elastic reset switch 3.2 regulates both said trip lever 3.1 and said elastic reset switch's 3.2 overall relative location to said planing cavity 1, controlling the size of the pencil-shape objects' front tip by adjusting when the front end of the pencil-shape object touches the elastic reset switch.

The circuit disconnector comprising said trip lever 3.1 and said flexible elastic reset switch 3.2 can simply, quickly, automatically, and accurately control the planning mechanism, thereby achieving fast, accurate, and automatic planing of the pencil-shape object. The apparatus in accordance with the present invention has the advantages of a reasonable structure design, easy operation, and facilitating users to quickly obtain sharpened pencil-shape objects.

The invention is not limited by the embodiments described above which are presented as examples only but can be modified in various ways within the scope of protection defined by the appended patent claims.

I claim:

1. An electric planing knife comprising:
a knife rest with a planing cavity formed within the knife rest and adapted to permit insertion of a pencil-shape object;
a cutter comprising a blade, wherein the cutter is mounted within said planing cavity; and
an electric circuit disconnector comprising a trip lever and a resilient elastic reset switch, said elastic reset switch being disposed under said planing cavity, the upper end of said elastic reset switch being located within said planing cavity, the upper end of said trip lever being connected with said elastic reset switch and being disposed below said elastic reset switch, said elastic reset switch being electrically connected to said cutter; and
a sharpness adjustor below the planing cavity.

2. The electric planing knife of claim 1, wherein said sharpness adjustor comprises a size adjustment slider being disposed below said trip lever and being pressed against the lower end of said trip lever, the contact surface between said size adjustment slider and said trip being inclined.

3. The electric planing knife of claim 2, wherein said size adjustment slider comprises a toggle handle for facilitating moving the adjustment slider.

4. The electric planing knife of claim 2 further comprising a stopper at each end of said size adjustment slider to set a boundary in the forward and backward directions of the adjustment slider.

5. The electric planing knife of claim 1 further comprising a guide sleeve so that said trip lever is constrained laterally and capable of moving axially in the guide sleeve.

6. The electric planing knife of claim 1 wherein the lower end of said trip lever has a spherical shape.

7. The electric planing knife of claim 1, wherein a waste collection box is disposed beneath said knife rest.
